(19) United States
(12) Patent Application Publication
(10) Pub. No.: US 2007/0114801 A1
(43) Pub. Date: May 24, 2007

(54) Transmission Device for Fireproofing Door Lock

(75) Inventor: Ching-Tien Lin, Taipei Hsien (TW)

Correspondence Address: SHOEMAKER AND MATTARE, LTD, 10 POST OFFICE ROAD - SUITE 110, SILVER SPRING, MD, 20910, US

(73) Assignee: Thase Enterprise Co., Ltd., Taipei Hsien (TW)

(21) Appl. No.: 11/467,718

(22) Filed: Aug. 28, 2006

(30) Foreign Application Priority Data
Nov. 9, 2005 (TW) 094219372

(51) Int. Cl. E05B 3/00

(52) U.S. Cl. 292/336.3

(57) ABSTRACT

A transmission device for a fireproofing door lock, comprises a lock shell assembly, a driving mechanism having an elastic sliding member and a shaft, an actuating mechanism for pushing the driving mechanism, and a locking mechanism selectively latching and restricting the elastic sliding member. The actuating mechanism comprises a horizontal handle arranged on an exterior surface of the lock shell assembly, a rotate button arranged in the lock shell assembly for pushing the elastic sliding member, and a switchable connect member connecting the rotate button and the horizontal handle, so that the direction of the horizontal handle can be easily changed and the problems of conventional technologies are thus solved.

### FIELD OF THE INVENTION

The present invention relates to a transmission device, and more specifically, to a transmission device arranged on a fireproofing door for transmitting a fireproofing door lock.

### BACKGROUND OF THE INVENTION

A fireproofing door generally provides fire isolation between floors and the stairwells of a building. In order to help prevent fire from spreading to other floors in the case of a fire, fireproofing doors are normally closed. However, for guaranteeing the safety of people inside a building, an inner side of a fireproofing door is arranged with a fireproofing door lock that can be easily opened, and an outer side of a fireproofing door is arranged with a transmission device for the lock.

A common fireproofing door lock is arranged on the inner surface of the fireproofing door, and has a handle frame transversely arranged on a central portion of the fireproofing door. The handle inside the handle frame is pressed so as to downwardly drag the latch inside the lock shell. The latch is therefore retracted to release the locking status of the fireproofing door lock, and the fireproofing door is thus opened.

A transmission device comprising a horizontal handle and lock core is arranged on the outer surface of the fireproofing door. The horizontal handle can be pressed so as to drive the latch inside the lock shell from the outer surface, consequently releasing the locking status of a fireproofing door to open the fireproofing door. In addition, a key can be inserted into the lock core to lock the horizontal handle to prevent entry from the outside while not interfering with exit from inside via pressing the handle to open it. TW Patent Publication No. 486011 and 414242 disclose such a conventional transmission device for fireproofing door lock.

The abovementioned prior art is composed of a lock shell assemble arranged with an actuating mechanism, a driving mechanism, and a locking mechanism. The actuating mechanism is employed to actuate the driving mechanism, and connect with the outside horizontal handle. The driving mechanism is employed to drive the latch of the fireproofing door lock when actuated by the actuating mechanism. The locking mechanism connects the outside lock core to lock the driving mechanism. When the horizontal handle is pressed, a turntable member of the actuating mechanism is rotated to actuate the driving mechanism, so that the shaft of the driving mechanism drives the latch of the fireproofing door lock, thus releasing the locked status of the fireproofing door lock. In the case of the lock core being locked via a key, the locking mechanism is driven to restrict the moving path of the driving mechanism, so that the actuating mechanism cannot actuate the driving mechanism, and the horizontal handle is therefore locked.

The above conventional prior-art horizontal handle is connected to the turntable member of the actuating mechanism via a shaft connecting with a C-shaped or E-shaped locking ring, and a cover plate is additionally arranged thereon for preventing detachment. However, after the transmission device is assembled and delivered, it is difficult to change the assembled status between the turntable member and the horizontal handle. That is, the direction of the horizontal handle is already defined in the assembly process, which cannot be changed after delivery. Such a design restricts the assembly of the horizontal handle to the surface of the fireproofing door in a single direction, which cannot satisfy an installation requirement for the fireproofing door that is opened from either the right side or the left side. As a result, a manufacturer has to define an assembly direction according to each specific order, which makes it more complicated and inconvenient for the manufacturing process, such as assembly, quality control, stock control, transportation, and the marketing process. An assembly operator (usually is site-assembly staff) has to pre-check the assembly direction of the fireproofing door and the number thereof, and then order corresponding transmission devices, which is inconvenient for the procurement process. Making matters worse, once the assembly direction of the fireproofing door is temporarily altered, the originally ordered transmission device with an opposite direction of operation can not be used, which may delay construction.

Additionally, the actuating mechanism actuates the driving mechanism via the turntable member, and the turntable is rotated when the horizontal handle is pressed, such that, in the course of the rotation, the turntable member simultaneously actuates the driving mechanism. However, in such a design that converts rotary movement into linear movement in a single direction, slippage will inevitably occur in the course of pushing. For a metallic surface, the slippage will generate considerable resistance and friction, wherein the resistance may hinder the operation of pressing the horizontal handle, which affects the quality of operation, and the friction may wear out the material, which, as a result, can cause deflection of the horizontal handle in operation.

Consequently, to solve the problems of the conventional technology, such that the direction of the horizontal handle of the transmission device can be easily changed, the operation of pressing the horizontal handle can be smoother, the friction caused by slippage can be reduced, and deflection of the horizontal handle can be prevented, a new design is desired.

### SUMMARY OF THE INVENTION

In view of the drawbacks of the above-mentioned conventional designs, an objective of the present invention is to provide a transmission device for a fireproofing door lock wherein the assembly direction of a horizontal handle can be easily changed.

Another objective of the present invention is to provide a transmission device for a fireproofing door lock wherein the horizontal handle can be smoothly pressed.

Still another objective of the present invention is to provide a transmission device for a fireproofing door lock wherein slippage is prevented.

Still another objective of the present invention is to provide a transmission device for a fireproofing door lock wherein deflection of the horizontal handle is prevented.

In accordance with the above objectives, the present invention provides a transmission device for a fireproofing door lock, the transmission device being arranged on a first lateral surface of the fireproofing door for driving the fireproofing door lock arranged on a second lateral surface of the fireproofing door, the transmission device comprising: a lock shell assembly arranged on the first lateral surface; a driving mechanism comprising an elastic sliding member elastically and movably arranged in the lock shell assembly, and a shaft rotated in response to the movement of the elastic sliding member for driving the fireproofing door lock; an actuating mechanism comprising a horizontal handle arranged on an exterior surface of the lock shell assembly, a rotate button arranged in the lock shell assembly for pushing the elastic sliding member, and a switchable connect member connecting the rotate button and the horizontal handle; and a locking mechanism arranged in the lock shell mechanism for selectively latching and restricting the movement of the elastic sliding member.

The rotate button and the horizontal handle respectively comprise a first insert hole and a second insert hole for connecting with the connect member. Preferably, the cross sections of the connect member, first insert hole, and second insert hole are rectangular-shaped for facilitating the selection of the assembly-direction of the horizontal handle.

The actuating mechanism further comprises a cover member arranged on the lock shell assembly for covering the rotate button and preventing the rotate button from detaching from the lock shell assembly, wherein the cover member defines an opening for exposing an end of the connect member. The rotate button comprises abrasion-proof contact portions for pushing the elastic sliding member on both lateral surfaces. Preferably, the abrasion-proof contact portion is a rotable member or an abrasion-proof layer, wherein the rotable member is selected from one of a bearing and a pulley, and the abrasion-proof layer is selected from one of a polishing surface and an abrasion-proof plating layer.

The lock shell assembly further comprises a plurality of fastening structures for securing the fireproofing door, wherein the fastening structure is selected from one of a screw hole and a screw post. The locking mechanism comprises a lock core secured to the lock shell assembly, and a lock shell linkage member moved by the lock core to a first position and a second position for latching and restricting the movement of the driving mechanism when the lock core linkage member is in the second position. The driving mechanism is arranged between the locking mechanism and the actuating mechanism. The shaft of the driving mechanism comprises a driving portion at an endmost portion thereof, wherein the driving portion is selected from one of a structure having a linear-shaped cross section and a structure having a cross-shaped cross section.

Compared with conventional technologies, in the transmission device for the fireproofing door lock of the present invention, the connect member can be switched to connect the rotate button and the horizontal handle, and the direction of the horizontal handle can be more easily changed, which better satisfies the installation requirements for a fireproofing door opened from the right side or the left side. At the same time, the design utilizing a rectangular-shaped connect member, first insert hole, and second insert hole can better assure that the horizontal handle is maintained in the horizontal status to prevent deflection from occurring. Additionally, the design of the abrasion-proof contact portions on both sides of the rotate button for pushing the elastic sliding member can assure smoother pressing of the horizontal handle, further preventing friction caused by the sliding from occurring. Consequently, the present invention solves the problems of conventional designs.

### BRIEF DESCRIPTION OF THE DRAWINGS

FIG. 1 is an exploded, partial view of a structure of a transmission device in accordance with the present invention;

FIG. 2 is a rear view of the transmission device;

FIG. 3 is an isometric view of a rotate button of the transmission device;

FIG. 4 is a perspective view showing the assembly of the transmission device to a fireproofing door lock;

FIG. 5 is a schematic view showing the transmission status when the horizontal handle of the transmission device is oriented in a first direction;

FIG. 6 is a schematic view showing a locked status of the transmission device; and

FIG. 7 is a schematic view showing the transmission status when the horizontal handle of the transmission device is oriented in a second direction.

### DETAILED DESCRIPTION OF THE PREFERRED EMBODIMENTS

The following embodiments are used to describe the present invention; those skilled in the art can easily understand other advantages and functions of the present invention via the contents disclosed in the description. Various embodiments can be employed in the present invention; and the details of the description can be based on and employed in various points of view, which can be derived from the scope of the present invention.

It is to be noted that the following figures are all simplified schematic figures, which are employed to illustrate the features of the present invention, wherein only those elements related to the features of the present invention are shown, the number, shape, and size of the elements are not being necessarily strictly identical to the practical embodiment, such that, in practical embodiments, the type, number, and proportion can be different, and the arrangement can be more complicated.

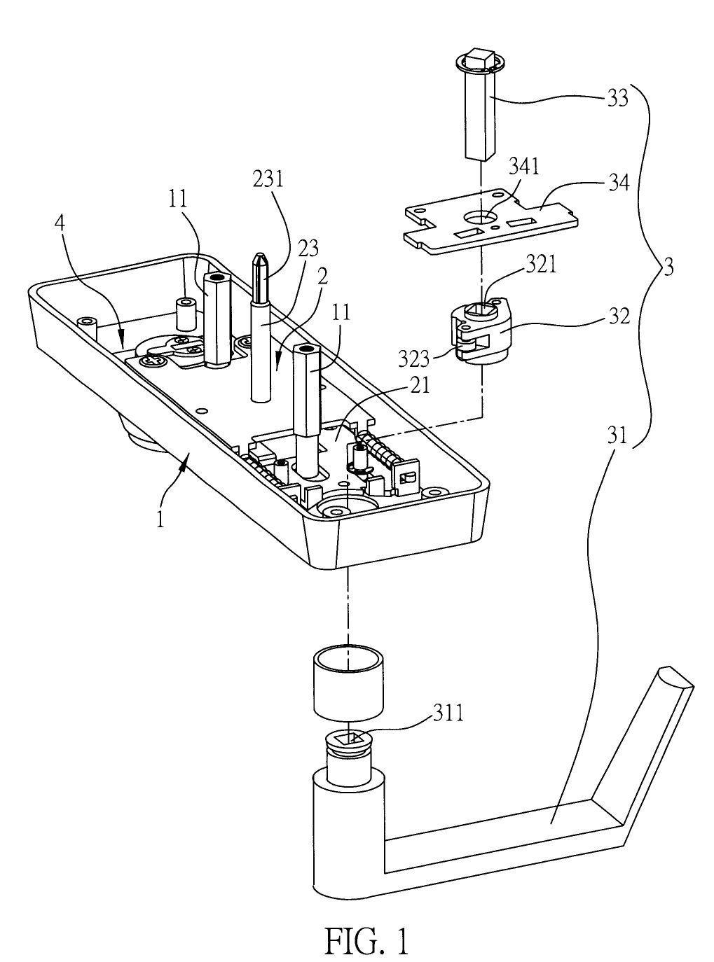

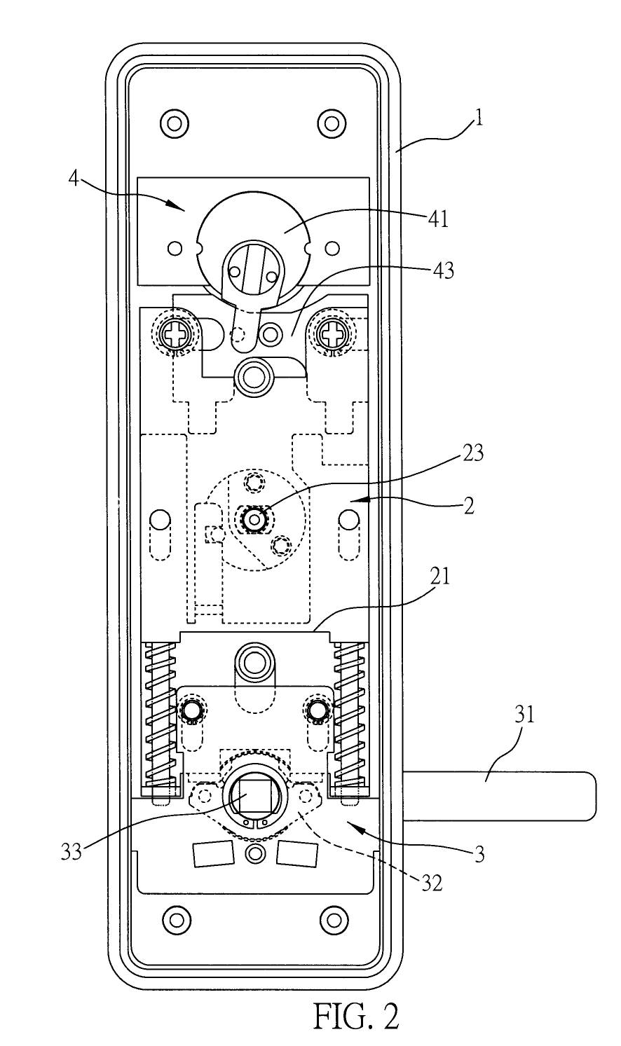

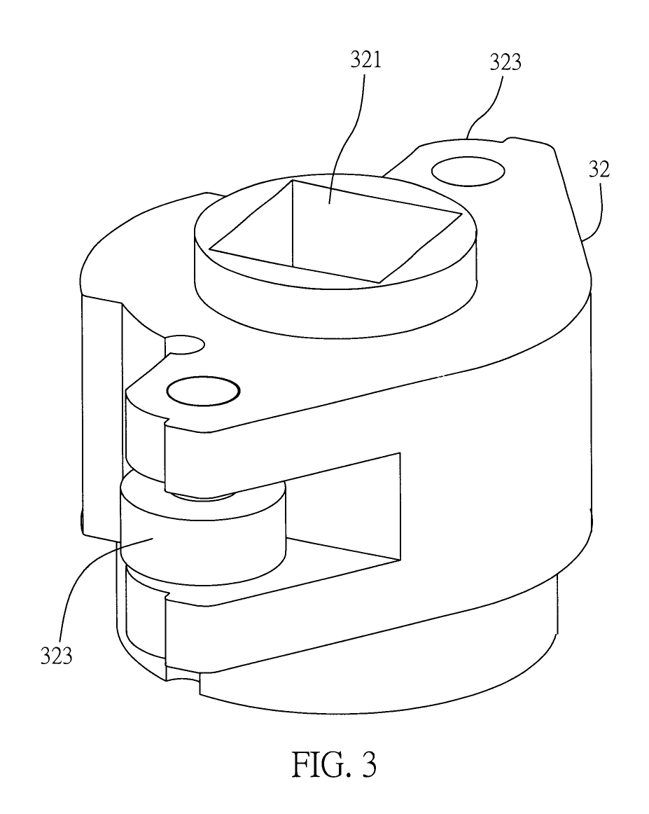

Referring to FIG. 1 to FIG. 3, views of a transmission device for a fireproofing door lock in accordance of an embodiment of the present invention are provided to illustrate the main features of the present invention, wherein FIG. 1 is an exploded, partial view of a structure of a transmission device in accordance with the present invention; FIG. 2 is a rear view of the transmission device; and FIG. 3 is an isometric view of a rotate button of the transmission device, all of which are detailed in the following description.

As shown in FIG. 1 and FIG. 2, the transmission device of the present invention comprises a lock shell assembly 1, a driving mechanism 2, an actuating mechanism 3, and a locking mechanism 4. The driving mechanism 2 can be elastically movably arranged in the lock shell assembly 1, the driving mechanism 2 comprising an elastic sliding member 21 and a shaft 23 which is rotated in response to the movement of the elastic sliding member 21. The actuating mechanism 3 comprises a horizontal handle 31 arranged on an exterior surface of the lock shell assembly 1, a rotate button 32 arranged in the lock shell assembly 1 for pushing the elastic sliding member 21, and a switchable connect member 33 connecting the rotate button 32 and the horizontal handle 31, the horizontal handle 31 being rotable to actuate the rotate button 32, thus pushing the elastic sliding member 21 of the driving mechanism 2. The locking mechanism 4 is arranged in the lock shell assembly 1 for selectively latching and restricting the movement of the driving mechanism 2.

The lock shell assembly 1 is arranged on a first lateral surface (generally an exterior surface) of the fireproofing door to arrange the driving mechanism 2, actuating mechanism 3 and the locking mechanism 4. The lock shell assembly 1 comprises a plurality of fastening structures 11, which, in the present embodiment, are screw posts perpendicularly protruding from the rear surface of the lock shell assembly 1; however, as can be understood by those skilled in the art, the screw posts can be replaced with screw holes in other embodiments to provide an equivalent fastening function, the selected components of the present embodiment not being posited as a limitation of the present invention.

The driving mechanism 2 can be elastically, movably arranged in the lock shell assembly 1, the driving mechanism 2 being correspondingly positioned between the locking mechanism 4 and the actuating mechanism 3. The driving mechanism 2 comprises an elastic sliding member 21 and a shaft 23 rotating in response to the movement of the elastic sliding member 21. The elastic sliding member 21 can be actuated by the actuating mechanism 3 to move towards the locking mechanism 4, and can automatically resume to its original position when the actuating mechanism 3 is released. The shaft 23 is rotated in the course of the movement of the elastic sliding member 21 to drive the fireproofing door lock. The shaft 23 comprises a driving portion 231 at an endmost portion thereof. In the present embodiment, the driving portion 231 can be a structure having a cross-shaped cross section; however, as can be understood by those skilled in the art, the structure having a cross-shaped cross section can also be replace by a linear-shaped one employed to drive the fireproofing door lock in other embodiments, the selected shape of the present embodiment not being posited as a limitation to the present invention. Additionally, the specific design of the driving mechanism 2 employing the elastic sliding member 21 continuously manipulating the shaft 23 is not a feature of the present invention, wherein specific structures, such as sliding plate, spring, turning rod, turntable and so on, can all be understood by those skilled in the art, and thus are not detailed hereinafter.

The actuating mechanism 3 comprises a horizontal handle 31 arranged on the main exterior surface of the lock shell assembly 1, a rotate button 32 arranged in the lock shell assembly 1 for pushing the elastic sliding member 21, and a switchable connect member 33 connecting the rotate button 32 and the horizontal handle 31. The horizontal handle 31 manipulates the rotate button 32 to push the elastic sliding member 21 of the driving mechanism 2. The rotate button 23 and the horizontal handle 31 respectively have a first insert hole 321 and a second insert hole 311 for connecting through the connect member 33. In the present embodiment, the cross sections of the connect member 33, first insert hole 321, and second insert hole 311 are all rectangular-shaped, facilitating easy selection of the assembly direction of the horizontal handle relative to the rotate button 32 or the lock shell assembly 1.

Additionally, the actuating mechanism 3 further comprises a cover member 34 arranged on the lock shell assembly 1 for covering the rotate button 32, thereby preventing the rotate button 32 from detaching from the lock shell assembly 1. The cover member 34 defines an opening 341 for exposing an end of the connect member 33, so that the connecting member 33 can be easily switched to change the assembly direction even after the cover member 34 is assembled. Furthermore, the rotate button 32 has abrasion-proof contact portions 323 (as shown in FIG. 3) employed to push the elastic sliding member 21. In the present embodiment, the abrasion-proof contact portion 323 is a rotate member, such as a bearing or a pulley; however, as can be understood by those skilled in the art, the abrasion-proof contact portion 323 can also be replaced by an abrasion-proof layer, such as a polishing surface or an abrasion-proof plating layer which provides an equivalent abrasion-proof function in other embodiments; therefore, what is described in the present embodiment is not to be regarded as a limitation to the present invention.

The locking mechanism 4 is arranged in the lock shell assembly 1, for selectively latching and restricting the movement of the driving mechanism 2. The locking mechanism 4 comprises a lock core 41 secured to the lock shell assembly, and a lock core linkage member 43 that can be moved to a first position and a second position by the lock core 41. When the lock core 41 is unlocked, the lock core linkage member 43 is in the first position staggered with the elastic sliding member 21; and when the lock core 41 is locked, the lock core linkage member 43 is in the second position latching the elastic sliding member 21. The movement path of the driving mechanism 2 is thus latched and restricted, and the rotate button 32 can not be rotated for pushing the elastic sliding member 21; consequently, the horizontal handle 31 can not be manipulated for actuating the driving mechanism 2.

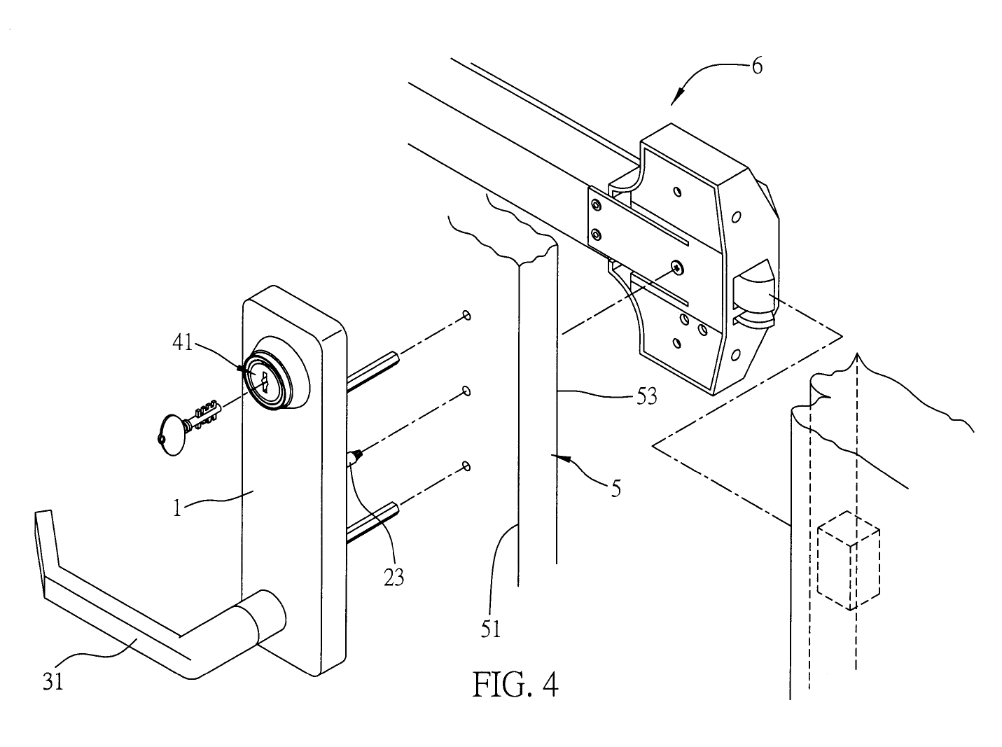

As shown in FIG. 4, the transmission device of the present invention is arranged on the first lateral surface 51 (generally the outer surface) of a fireproofing door via the rear surface of the lock shell assembly 1 in contact with the fireproofing door. The lock core 41 and the horizontal handle 31 arranged on the front surface are exposed, so that the horizontal handle 31 can be manipulated to drive the shaft 23, which then further drives the fireproofing door lock 6 arranged on the second lateral surface 53 (inner surface) of the fireproofing door via the shaft 23.

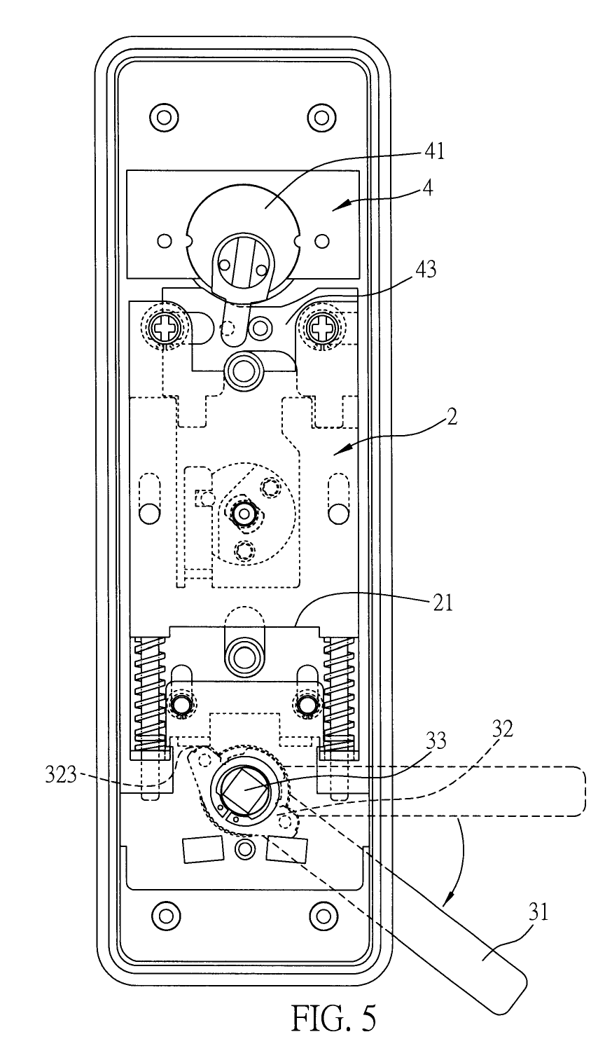

As shown in FIG. 5, when the lock core 41 of the locking mechanism 4 is in an unlocked status, the lock core linkage member 43 is in the first position staggered with the elastic sliding member 21, so that the horizontal handle 31 can be manipulated to actuate the rotate button 32 via the connecting member 33 to drive the shaft 23 to rotate, and the elastic sliding member 21 of the driving member 2 can be pushed towards the locking mechanism via the abrasion-proof contact portion 323 on a lateral surface of the rotate button 32, thus further driving the shaft 23 to rotate, so that the fireproofing door lock is opened via force transmitted by the shaft 23.

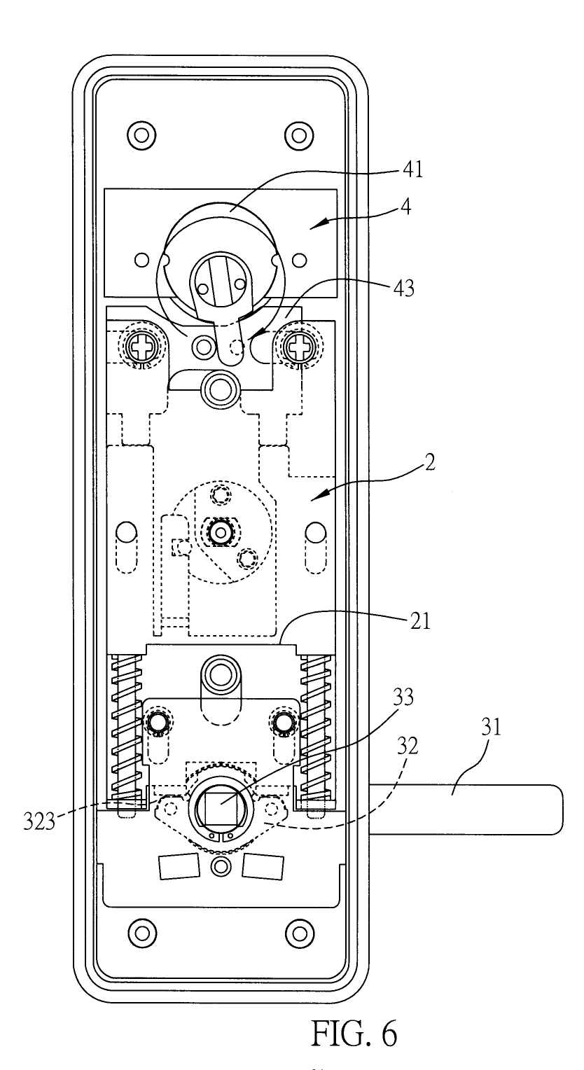

As shown in FIG. 6, when the lock core 41 of the locking mechanism 4 is in a locked status, the lock core linkage member 43 is moved to the second position latching the elastic sliding member 21, so that the movement of the driving mechanism 2 is latched and restricted, the rotate button 32 cannot be rotated to push the elastic sliding member 21, and the horizontal handle 31 can not be manipulated to actuate the driving mechanism 2.

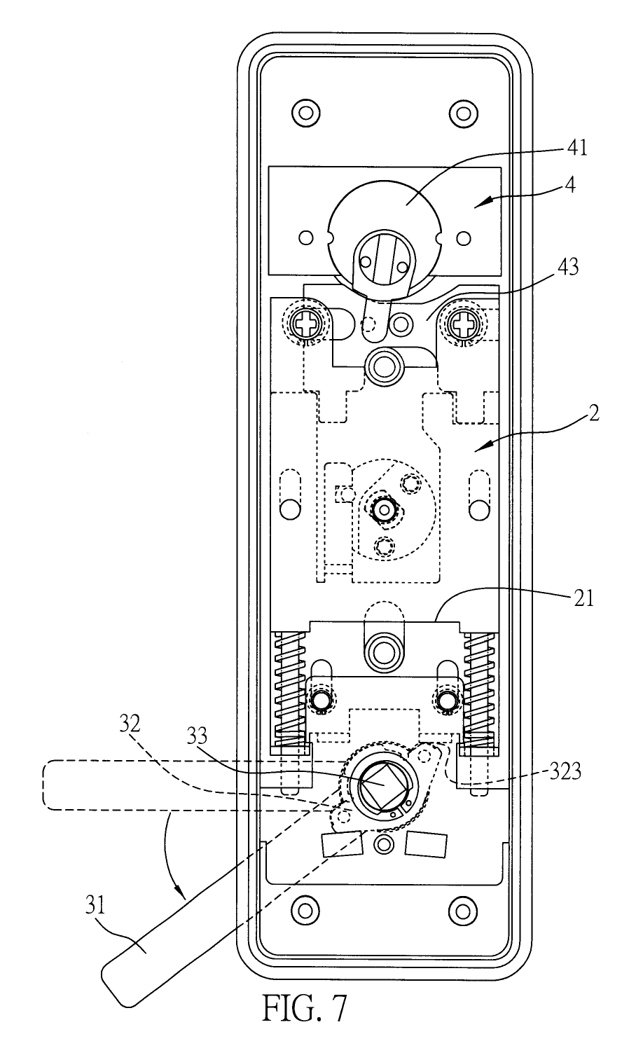

Additionally, the connect member 33 can be easily drawn out from the first insert hole 321 of the rotate button 32 and the second insert hole 311 of the horizontal handle 31, and the connect member 33 can be inserted to reconnect via adjusting the direction of the horizontal handle 31, so that the direction of the horizontal handle 31 can be correspondingly drawn out and adjusted in accordance with the installation requirements of a fireproofing door opened from the right side or the left side. As shown in FIG. 7, after the direction of the horizontal handle 31 is changed, and the lock core 41 of the locking mechanism 4 is in the unlocked status, the horizontal handle 31 can be 12 manipulated to actuate the rotate button 32 via the connect member 33 to rotate the shaft 23, and the elastic sliding member 21 of the driving mechanism 2 is then pushed to move towards the locking mechanism by the abrasion-proof contact portion 323 on another lateral surface of the rotate button 32 to further rotate the shaft 23, so that the fireproofing door lock is opened via force transmitted by the shaft 23.

Although the above embodiment is described with the example of changing the assembly direction of the horizontal handle, it can be understood by those skilled in the art that the design of the rectangular-shaped connect member, first insert hole, and second insert hole provides a switching direction every 90 degrees (that is, there are four total switching directions), which is convenient for packing the transmission device, and, furthermore, the horizontal handle can be arranged parallel to the lock shell assembly in the course of manufacturing or assembly for reducing the required space, thus further facilitating packing and delivery.

Because, in the transmission device for a fireproofing door lock of the present invention, the connect member can be switched to connect the rotate button and the horizontal handle, the direction of the horizontal handle can be more easily changed, which satisfies the installation requirement for a fireproofing door that is easily configurable to be opened from the right side or the left side. At the same time, the design of rectangular-shaped connect member, first insert hole, and second insert hole can further assure that the horizontal handle is maintained in the horizontal status to prevent deflection from occurring. Additionally, the design of the abrasion-proof contact portions on both sides of the rotate button for pushing the elastic sliding member can assure smoother pressing of the horizontal handle, further preventing friction caused by sliding contact from occurring. Consequently, the present invention solves the problems of the conventional technologies.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

1. A transmission device for a fireproofing door lock, the transmission device being arranged on a first lateral surface of the fireproofing door for driving the fireproofing door lock arranged on a second lateral surface of the fireproofing door, the transmission device comprising:
a lock shell assembly arranged on the first lateral surface;
a driving mechanism comprising an elastic sliding member elastically and movably arranged in the lock shell assembly, and a shaft rotated in response to the movement of the elastic sliding member for driving the fireproofing door lock;
an actuating mechanism comprising a horizontal handle arranged on an exterior surface of the lock shell assembly, a rotate button arranged in the lock shell assembly for pushing the elastic sliding member, and a switchable connect member connecting the rotate button and the horizontal handle; and
a locking mechanism arranged in the lock shell mechanism for selectively latching and restricting the movement of the elastic sliding member.

2. The transmission device for a fireproofing door lock as claimed in claim 1, wherein the rotate button and the horizontal handle respectively comprise a first insert hole and a second insert hole for connecting the connect member.

3. The transmission device for a fireproofing door lock as claimed in claim 2, wherein the cross sections of the connect member, first insert hole and second insert hole are rectangular-shaped.

4. The transmission device for a fireproofing door lock as claimed in claim 1, wherein the actuating mechanism further comprises a cover member arranged on the lock shell assembly for covering the rotate button.

5. The transmission device for a fireproofing door lock as claimed in claim 4, wherein the cover member defines an opening for exposing an end of the connect member.

6. The transmission device for a fireproofing door lock as claimed in claim 1, wherein the rotate button comprises abrasion-proof contact portions for pushing the elastic sliding member on both lateral surfaces.

7. The transmission device for a fireproofing door lock as claimed in claim 6, wherein the abrasion-proof contact portion is a rotable member.

8. The transmission device for a fireproofing door lock as claimed in claim 7, wherein the rotable member is selected from one of a bearing and a pulley.

9. The transmission device for a fireproofing door lock as claimed in claim 6, wherein the abrasion-proof contact portion is an abrasion-proof layer.

10. The transmission device for a fireproofing door lock as claimed in claim 9, wherein the abrasion-proof layer is selected from one of a polishing surface and an abrasion-proof plating layer.

11. The transmission device for a fireproofing door lock as claimed in claim 1, wherein the lock shell assembly further comprises a plurality of fastening structures for securing the fireproofing door.

12. The transmission device for a fireproofing door lock as claimed in claim 11, wherein the fastening structure is selected from one of a screw hole and a screw post.

13. The transmission device for a fireproofing door lock as claimed in claim 1, wherein the locking mechanism comprises a lock core secured to the lock shell assembly, and a lock shell linkage member moved by the lock core to a first position and a second position for latching and restricting the movement of the driving mechanism when the lock core linkage member is in the second position.

14. The transmission device for a fireproofing door lock as claimed in claim 1, wherein the driving mechanism is arranged between the locking mechanism and the actuating mechanism.

15. The transmission device for a fireproofing door lock as claimed in claim 1, wherein the shaft of the driving mechanism comprises a driving portion at an endmost portion thereof.

16. The transmission device for a fireproofing door lock as claimed in claim 15, wherein the driving portion is selected from one of a structure having a linear-shaped cross section and a structure having a cross-shaped cross section.
